(19) United States
(12) Patent Application Publication
(10) Pub. No.: US 2015/0206228 A1
(43) Pub. Date: Jul. 23, 2015

(54) Peer-To-Peer Resource Leasing

(71) Applicants: Alberto Martin Perez, Kirkland, WA (US); Dave Iain MacLachlan, Redmond, WA (US)

(72) Inventors: Alberto Martin Perez, Kirkland, WA (US); Dave Iain MacLachlan, Redmond, WA (US)

(73) Assignee: GOOGLE INC., Mountain View, CA (US)

(21) Appl. No.: 13/491,981

(22) Filed: Jun. 8, 2012

(51) Int. Cl. G06Q 30/06; G06Q 10/00; G06Q 20/22; G06Q 30/08; G06Q 30/02

(52) U.S. Cl. CPC G06Q 30/0645; G06Q 30/08; G06Q 30/0278

(57) ABSTRACT

Described herein are techniques related to a lessee leasing resources on a lessor's computing device. This Abstract is submitted with the understanding that it will not be used to interpret or limit the scope and meaning of the claims. A resource-leasing tool allows a lessee, using peer-to-peer communication, to use an application on a lessor's computing device while the leased resource is installed and run on the lessor's computing device.

### BACKGROUND

User devices such as desktop computers are getting more powerful while other user devices such as tablets, smart phones, laptops, and the like, are getting thinner and have less computing power. At any given time, however, the more powerful computing device may actually be idle. Moreover, even if not idle, the more powerful computing device may not be operating at full capacity.

### SUMMARY

In general, one implementation of the subject matter disclosed herein is directed to a resource-leasing tool. The resource-leasing tool includes a resource-directory device that is configured to register, via a message-exchanging communication protocol, a resource on a lessor computing device that is available for lease. The resource-directory device is further configured to obtain an indication that a lessee wants to lease the resource for use on a lessee computing device.

The resource-leasing tool includes a lease-valuation system that is configured to determine a value for a lease of the resource based upon one or more of a start time for the lease, a duration of the lease, or the resource being leased. The resource-leasing tool includes a lessee verifier that is configured to determine whether the lessee has permission to lease the resource.

The resource-leasing tool includes a peer-to-peer communication interface that is configured to facilitate a peer-to-peer connection between the lessor computing device and a lessee computing device using a peer-to-peer communication protocol in response to a determination that the lessee has permission to lease the resource. The resource-leasing tool also includes a video codec that is configured to enable, using the peer-to-peer connection, the lessee to use the resource on the lessee computing device while the resource is running on the lessor computing device.

This Summary is submitted with the understanding that it will not be used to interpret or limit the scope or meaning of the claims. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an example resource-leasing environment according to one or more implementations described herein.

FIG. 2 illustrates an example of the user interface depicted in FIG. 1 according to one or more implementations described herein.

FIG. 3 illustrates an example of the resource-leasing tool according to one or more implementations described herein.

FIG. 4 illustrates an example of a lease-valuation system according to one or more implementations described herein.

FIG. 5 is a flowchart of a method for leasing computing resources according to one or more implementations described herein.

FIG. 6 is a high-level block diagram illustrating an example computer system suitable for implementing the technology described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

The technology described herein includes a resource-leasing tool that allows a user of one computer to lease resources of a different computer. A resource-directory device in the tool keeps track of resources that are available for lease.

With one or more implementations described herein, the resource-directory device scans the lessor's computer for resources. Whatever the resource-directory device finds are registered with the resource directory device using a message-exchanging protocol, such as Extensible Messaging and Presence Protocol (XMPP). In one or more implementations, the resource-directory device finds applications, user interfaces, web browsers, and the like. The resource-directory device also determines whether there is available disk space, central processing unit (CPU) time, programming language compilers, printer access, plotter access, iPod® access, etc., and registers that information to the resource directory device as well.

With some implementations, the resources for lease include legacy web browsers and platforms. For example, a web designer might want to see what her web page looks like or even if it renders at all in a different browser or on a different platform. The web designer would be able to lease these resources for this purpose.

With one or more implementations described herein, a potential lessee's computer has a user interface (UI) that lists the resources that are available for lease, along with times the resources are available, the prices, and the duration of the lease. Pricing is based on the time of day the resource is needed, the duration of the lease, the popularity of that particular resource, etc.

With one or more implementations described herein, an auction system establishes the pricing for each resource being leased. The auction system determines, for example, that a photo editing application has a lease price of $0.01 per hour, a computer-aided drafting application has a lease price of $0.05 per hour, and a programming language compiler has a lease price of $0.15 per hour. In this auction implementation, prices are determined by what a lessee is willing to pay, as indicated by bids. Alternatively, the resources may be leased on a fixed-price basis.

With one or more implementations described herein, a payment system places payments, including micropayments, into escrow until leased resources are consumed. Alternatively, instead of making monetary payments, a lessee may be asked to watch an advertisement in exchange for gaining access to a resource.

The potential lessee uses her UI to select the resource, time desired, duration desired, etc. When the time for lease approaches, the lessor's computer receives a message, through her calendar, for example, that a lease is about to begin and to relinquish the computer for use by the lessee. The lessee's computer and the lessor's computer exchange messages to establish peer-to-peer communication, either directly or through a relay server. The peer-to-peer communication session uses a peer-to-peer communication protocol, such as libjingle, Skype, Teredo, or the like.

When the communication session is approved, a video codec facilitates lessee access to the resource on the lessor's computer using the peer-to-peer connection so the lessee can manipulate the resource that the lessee has leased. That is, the video codec encodes captured user interface (UI) input, such as mouse movements, mouse clicks, key presses on the keyboard, etc., into a video stream and transmits the encoded video stream to the lessee device. The lessee device also includes a video codec, which decodes the encoded video stream and plays the mouse movements, mouse clicks, key presses on the keyboard, etc., that are in the decoded video stream.

With one or more implementations described herein, the lessee device's video codec also encodes captured user interface (UI) input, such as mouse movements, mouse clicks, key presses on the keyboard, etc., into a video stream and transmits the encoded video stream to the lessor device. The lessor device decodes the encoded video stream.

### Example Environment Implementing Resource-Leasing

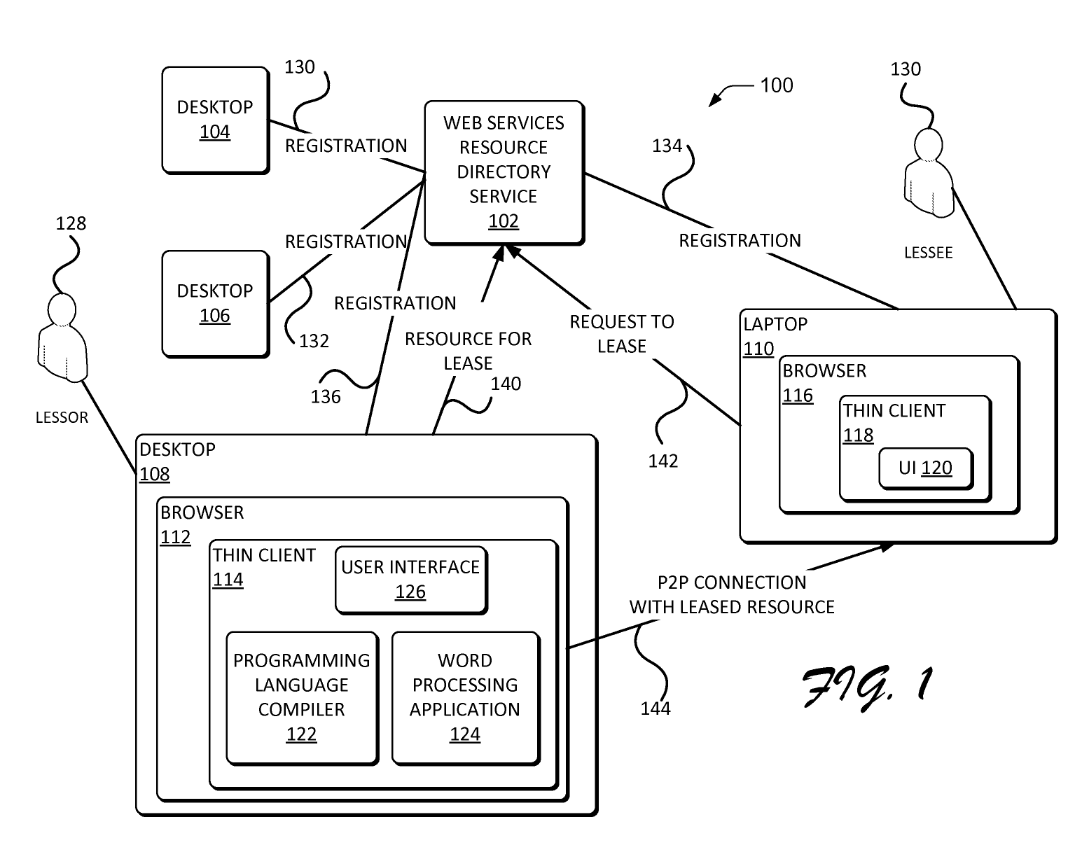

FIG. 1 illustrates an example resource leasing environment 100 according to one or more implementations described herein in which a lessee leases a resource to a lessee. The illustrated environment 100 includes a web services directory service 102, three desktop computers 104, 106, and 108, and a laptop computer 110. The illustrated desktop 108 includes a browser 112 and a thin client 114. The illustrated laptop 110 includes a browser 116 and a thin client 118. The illustrated thin client 118 includes a user interface (UI) 120. The illustrated thin client 114 includes a programming language compiler 122, a word processing application 124, and a user interface (UI) 126. The lessor 128 uses the desktop 108, and the lessee 130 uses the laptop 110.

In one or more implementations, the illustrated environment 100 is intended represent, among other things, any large multinational corporation, not-for-profit organization, government entity, and the like.

In one or more implementations, the directory service 102 is a service provided by a device that, stores, organizes, and provides access to information obtained from computing devices in the environment 100 during registration and subsequent use of the directory by the computing devices.

A suitable directory service includes an Amazon Web Services (AWS) directory service application programming interface (API) provided by Amazon, a Slicehost directory service API provided by Rackhost, a Linode directory service API provided by Linode, a Google App Engine directory service API provided by Google, and the like.

In one or more implementations, the desktop computers 104, 106, and 108 are personal computers that are intended to be used at a single location as opposed to a mobile computer such as a laptop computer.

In one or more implementations, the laptop computer 110 is intended to represent any portable personal computer. This includes netbook computers, notebook computers, and tablet computers, subnotebook computers, and the like.

In one or more implementations, the browser 112 is a multi-process web browser that handles the user interface 126 and manages other processes that run on top of the browser 112, such as one or more renderer processes, plugin processes, extension processes, and the like.

In one or more implementations, the thin client 114 accesses the directory service 102 via the browser 112. Thin client 114 can be a web browser plugin or a web browser extension. The browser extension can be created with web technologies. The browser extension can also include a native code module designed to run in a sandboxed environment directly on underlying hardware. The thin client 114 can also be a computer that has limited computing power, such as a computer terminal.

In one or more implementations, the browser 116 is a multi-process web browser that handles the user interface 120 and manages other processes that run on top of the browser 116, such as one or more renderer processes, plugin processes, extension processes, and the like.

The thin client 118 accesses the directory service 102 via the browser 116. Thin client 118 can be a web browser plugin or a web browser extension. The browser extension can be created with web technologies. The browser extension can also include a native code module designed to run in a sandboxed environment directly on underlying hardware. The thin client 118 can also be a computer that has limited computing power, such as a computer terminal.

In one or more implementations, the user interface 120 is an interface in which the user enters commands, selects menu option, selects icons, and the like, in keeping with what is displayed on the screen of the laptop 110.

In one or more implementations, the programming language compiler 122 is any program that translates source code into another programming language. For example, the compiler 122 is a C compiler, such as a C++ compiler.

In one or more implementations, the word processing application 124 is any word processing application that is used to compose, edit, format, and print, for example, documents such as articles, newsletters, and the like.

In one or more implementation, the user interface 126 is an interface in which the user enters commands, selects menu option, selects icons, and the like, in keeping with what is displayed on the screen of the desktop 108.

In one or more implementations, the lessor 128 is a user of the desktop 108 that has resources that are available for lease. The lessee 130 is a user of the laptop 110 that leases the resources that the lessor 128 has available for lease.

### Example Resource-Leasing Environment Operation

In one or more implementations, the resource-leasing environment 100 operates as follows. At a point 130, the desktop 104 registers with the directory service 102. At a point 132, the desktop 106 registers with the directory service 102. At a point 134, the desktop 108 registers with the directory service 102. At a point 136, the laptop 110 registers with the directory service 102 at point 136. The directory service 102 uses a message-exchanging protocol, such as XMPP, to communicate with the desktops 104, 106, and 108, and the laptop 110. Registration of the desktops 104, 106, and 108, and the laptop 110 enables remote access to the desktops 104, 106, and 108, and the laptop 110.

The directory service 102 scans the desktops 104, 106, and 108, and the laptop 110 for resources, searching for .app files, .exe files, .apk files, .jar files, etc. The directory device 102 also scans for scripts, such as compiler scripts, and the like. The directory device 102 also searches for web browsers, such as legacy browsers, for example, hard drive space, and available memory.

At a point 140, the directory service 102 finds that the desktop 108 has a resource that is available for lease. In one or more implementations, the resource is the browser 112, the programming language compiler 122, the word processing application 124, and/or the user interface 126.

At a point 142, the user 130 of the laptop 110 requests to lease a resource that the lessor 128 has for lease.

### Example Lessee User Interface

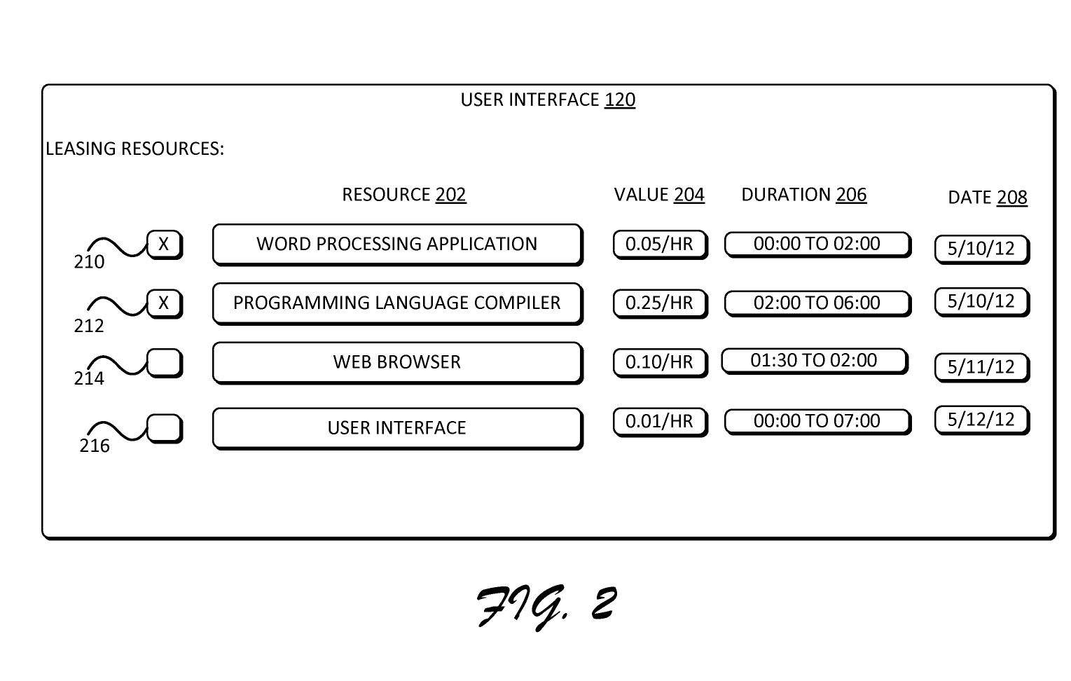

FIG. 2 illustrates an example of the user interface (UI) 120 on the laptop 110 that is used to request a lease of a resource that the desktop 108 has for lease. In the illustrated implementation, the UI 120 includes a resource column 202, a value column 204, a duration column 206, and a date column 208. The UI 120 also includes selection boxes 210, 212, 214, and 216. In one or more implementations, the location of the resources offered in the resource column 202 is transparent to the lessee 130. That is, the lessee 130 does not know whether the leasable resources are on the desktop 104, the desktop 106, the desktop 108, and/or some other device in the resource-leasing environment 100, for example.

In the illustrated implementation, the resource column 202 includes an entry for a word processing application. The value column 204, the duration column 206, and the date column 208 indicate that the word processing application 124 can be leased for 0.05 cents per hour for times between midnight and 2:00 a.m. on the date of May 10, 2012. The lessee 130 has indicated that she would like to lease the word processing application 124 by checking the box 210 on the user interface 120.

In the illustrated implementation, the resource column 202 includes an entry for a programming language compiler. The value column 204, the duration column 206, and the date column 208 indicate that the programming language compiler can be leased for 0.25 cents per hour for times between the hours of 2:00 a.m. and 6:00 a.m. on the date of May 10, 2012. The lessee 130 has indicated that she would like to lease the programming language compiler by checking the box 212 on the user interface 120.

In the illustrated implementation, the resource column 202 includes an entry for a web browser. The value column 204, the duration column 206, and the date column 208 indicate that the web browser can be leased for 0.10 cents per hour for times between 1:30 a.m. and 2:00 a.m. on the date of May 11, 2012. The lessee 130 has not indicated that she would like to lease the web browser because the box 214 on the user interface 120 is not checked.

In the illustrated implementation, the resource column 202 includes an entry for a user interface. The value column 204, the duration column 206, and the date column 208 indicate that the user interface can be leased for 0.01 cents per hour for times between midnight and 7:00 a.m. on the date of May 12, 2012. The lessee 130 has not indicated that she would like to lease the user interface because the box 216 on the user interface 120 is not checked.

### Example Resource Leasing Tool

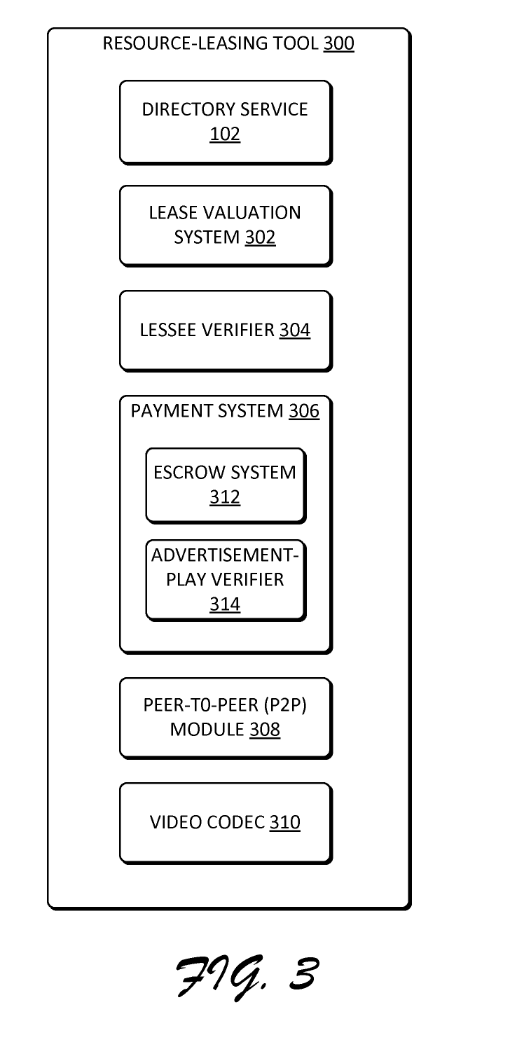

FIG. 3 illustrates an example of the resource-leasing tool 300 according to one or more implementations described herein. In the illustrated implementation, the resource-leasing tool 300 includes the directory service 102, a lease valuation system 302, a lessee verifier 304, a payment system 306, a peer-to-peer (P2P) module 308, and a remote access module 310. In the illustrated implementation, the payment system 306 includes an escrow system 312 and an advertisement-play verifier 314.

In one or more implementations, the lease valuation system 302 is configured to determine a value for the lease of a resource. For example, the lessee uses an auction system to bid on the lease. The bids determine the value of the lease. The lease value alternatively is a fixed price value. Alternatively still, the lease granted is in exchange for viewing of an advertisement. The lease value can also be bartered. For example, the lessor can lease her computing resource in exchange for a coupon or a discount for merchandise, service, etc., to which the lessee has access.

In one or more implementations, the lessee verifier 304 receives the selection of the resource from the lessee 130 and determines whether the lessee 130 has permission to use the word processing application. For example, the user 130 checks the box 210 and the lessee verifier 304 queries the directory service 102 to determine whether the lessee 130 has permission to use the word processing application. The directory service 102 queries the registration information for the laptop 110 and informs the lessee verifier 304 that the laptop 110 has permission to access the word processing application.

In one or more implementations, the payment system 306 is configured to obtain micro-payments, for example, for the lease of the word processing application 124 from the lessee 130. The payment system places the lessee's payment in the escrow system 312 until the lessee's leasing session has ended. The escrow system 312 then releases the payment for the lease to the lessor 128.

Alternatively, the lessee 130 is requested to view an advertisement in exchange for the lease. The advertisement-play verifier 314 determines whether the advertisement played, in its entirety, for example. If so, then the advertisement-play verifier 314 indicates that the lessee has viewed the advertisement and the lessee is permitted to access the word processing application.

In one or more implementations, once the lessee 130 is permitted to use the word processing application 124 and the appointed time arrives, the P2P module 308 sets up peer-to-peer communication between the laptop 110 and the desktop 108 so that the lessee 130 can use the word processing application 124 that is installed on the desktop 108.

In one or more implementations, the P2P module 308 implements a P2P protocol such as libjingle. Libjingle is an open source library that is used to build peer-to-peer connections for file-sharing, voice, video, and other peer-to-peer communications. Libjingle handles connection negotiation and data exchange between peer client devices that is used create a network connection, negotiate session details, and exchanging data. Libjingle also parses Extensible Markup Language (XML) and handles network proxies. Libjingle uses a variety of transport mechanisms, such as Transmission Control Protocol (TCP), Universal Datagram Protocol (UDP), Real-Time Transport Protocol (RTP), and in-band Extensible Messaging and Presence Protocol (XMPP).

In one or more implementations, libjingle implements an interactive connectivity establishment (ICE) protocol to set up peer-to-peer communication sessions. For example, libjingle uses Traversal Using Relay Network Address Translation (TURN) protocol to set up a peer-to-peer communication session that uses a relay server as an intermediary. Alternatively, libjingle uses Session Traversal Utilities for Network Address Translators (STUN) protocol to set up a peer-to-peer communication session.

In one or more implementations, the P2P module 308 exchanges STUN binding request and response messages between the desktop 108 and the laptop 110. In one or more implementations, the P2P module 308 exchanges TURN allocate request and response messages between desktop 108 and the laptop 110.

In one or more implementations, the P2P module 308 on the desktop 108 includes a daemon, which facilitates setting up the P2P communication session with the laptop 110. For example, the daemon reports the status of the desktop 108, e.g., whether the desktop 108 awake, reachable, etc. The daemon also reports whether or not the desktop 108 has a port that can be connected to by the laptop 110 for the P2P communication session. The daemon also maintains the communication for the duration of the use of the word processing application 124 by the laptop 110.

In one or more implementations, the P2P module 308 on the desktop 108 also includes an extension. The extension is used to connect the desktop 108 to the laptop 110. The extension includes the messages for the P2P module 308 to communicate with the browser on the desktop 108. The extension includes hooks that tie into the Extensible Messaging and Presence Protocol (XMPP) for STUN and TURN libjingle sessions.

In one or more implementations, the extension also includes hooks that tie into the user interface (UI) elements to enable the remote access module 310 on the desktop 108 to capture the UI inputs.

Alternatively, an implementation of the P2P module 308 may use any protocol that functions to set up a peer-to-peer connection, such as Skype, for example.

In one or more implementations, the remote access module 310 is any suitable video codec that encodes and/or compresses digital and/or analog video into a video stream. The video codec also is any suitable video codec that decodes and/or decompresses a digital video stream. Suitable video codecs include H.264 codecs, VP8 codecs, Motion Picture Experts Group (MPEG) codecs, or the like.

In one or more implementations, the remote access module 310 enables the lessee 130 to use the word processing application 124 on the laptop 110 even though the word processing application 124 is installed and running on the desktop 108. For example, the word processing application 124 is installed and running on the desktop 108 but the laptop 110 renders the word processing application 124 so the lessee 130 can use the word processing application 124 on the laptop 110. The remote access module 310 in concert with the P2P module 308 enables the word processing application 124 to run on the desktop 108 and render on the laptop 110.

In one or more implementations, when the word processing application 124 is running on the desktop 108, the remote access module 310 captures the user interface (UI) 126 output (i.e., what is displayed on the screen of the desktop 108) from the word processing application 124 that is running on the desktop 108. remote access module 310 encodes the captured UI output as a video stream and transmits the encoded video stream to the laptop 110. The laptop 110 renders the encoded video stream.

In one or more implementations, the remote access module 310 captures the UI 120 inputs on the laptop 110, such as mouse movements, mouse clicks, key presses on the keyboard, etc., encodes them as a video stream, and transmits the encoded video stream to the desktop 108. The remote access module 310 plays the mouse movements, mouse clicks, key presses on the keyboard, etc., that are encoded in the video stream on the desktop 108.

In one or more implementations, the resource-leasing tool 300 on the desktop 108 includes an extension that is used to connect the desktop 108 to the laptop 110. The extension includes the messages for the P2P module 308 to communicate with the browser 112 on the desktop 108. In one or more implementations, the extension includes hooks that tie into the Extensible Messaging and Presence Protocol (XMPP) for STUN and TURN libjingle sessions. In one or more implementations, the extension also includes hooks that tie into the UI elements to enable the remote access module 310 on the desktop 108 to capture the UI 126 inputs from the desktop 108.

In one or more implementations, the extension also includes hooks that tie into the user interface (UI) 120 elements to enable the remote access module 310 on the laptop 110 to capture the UI 120 inputs when the user 130 is manipulating the word processing application.

In one or more implementations, the remote access module 310 decodes the video stream transmitted to the laptop 110 by the desktop 108. The extension also includes a receiver that the remote access module 310 uses to receive the encoded video stream from the desktop 108.

### Example Lease-Valuation System

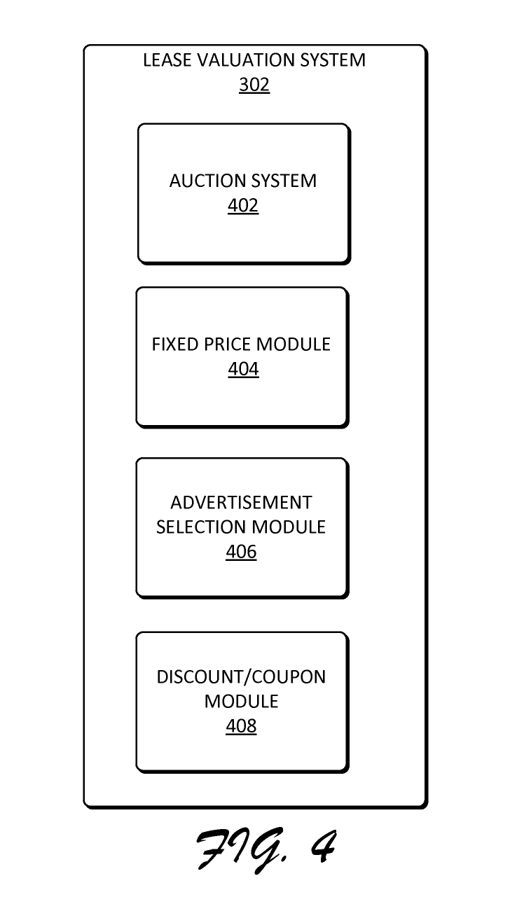

FIG. 4 illustrates an example of the lease-valuation system 302 depicted in FIG. 3 according to one or more implementations described herein. In the illustrated implementation, the lease-valuation system 302 includes an auction system 402, a fixed-price module 404, an advertisement-selection module 406, and a discount/coupon module 408.

In one or more implementations, the auction system 402 is any suitable system that allows potential lessees to bid on leases for selected resources. The auction system 402 includes an indication of what resources are available to be leased, what type of network connection exists to the resource, what the reliability of the particular leasable resource is, based on the time and other statistics that may influence performance of the resource and general desirability.

In one or more implementations, the auction system 402 includes a heartbeat communications protocol that exchanges messages between the desktop 108, the directory service 102, and/or the laptop 110 to determine the network conditions for the devices that are available. For example, to determine the speed of the network connection to the desktop 108 the auction system 402 in the desktop 108 sends an XMPP ping to the directory service 102 and measures the time it takes to send and/or receive the XMPP messages. Alternatively, the P2P module 308 in the desktop 108 pings the laptop 110 using a P2P communication protocol to determine how long it takes for the laptop 110 to respond to the ping. The desktop 108 and/or the laptop 110 may display the result of the ping.

In one or more implementations, to evaluate the performance of the desktop 108 the auction system 402 on the desktop 108 uses a Netscape Plugin Application Program Interface (NPAPI) plugin on the desktop 108 to access and measure the performance of the central processing unit (CPU), graphics processing unit (GPU), operating system (OS), hard drive, etc., on the desktop 108. The results gathered are compared to known benchmarks to evaluate the performance of the desktop 108.

In one or more implementations, the fixed-price module 404 includes prices for the selected leasable resource based on the particular resource, the time of day, the duration of use, and the like. For example, the directory service 102 includes logs of peak hours versus down time for the selected leasable resource. The fixed price module 404 in one or more implementations consults the logs and adjusts the lease pricing based on the logged times. The fixed price module 404 also uses the logs to determine lessee demand based on historical data in the logs.

In one or more implementations, the advertisement-selection module 406 customizes advertisements for the lessee 130. The advertisement-selection module 406 uses demographic information, preferences indicated by the lessee 130, etc., to select advertisements that are presented to the lessee 130. Advertisements are in the form of video advertisements, audio advertisements, stills, etc. Suitable technologies for implementing the advertisement-selection module 406 include AdSense by Google, Kontera by Kontera Technologies, Inc., Clicksor by Clicksor Inc., and the like.

In one or more implementations, the discount/coupon module 408 permits the lessee 130 to offer her services, resources, merchandise, etc., to the lessor 128 in exchange for the lease of the selected resources. For example, the services, resources, and/or merchandise are offered in the form of a coupon, such as “in exchange for the use of the selected resource, I will give you 60% off a massage.” Suitable technologies for implementing the discount/coupon module 408 include virtual goods systems by Zynga® by Zynga Game Network, Inc., Gaia Online® by Gaia Interactive, Inc., and the like.

### Example Resource-Leasing Tool Operation

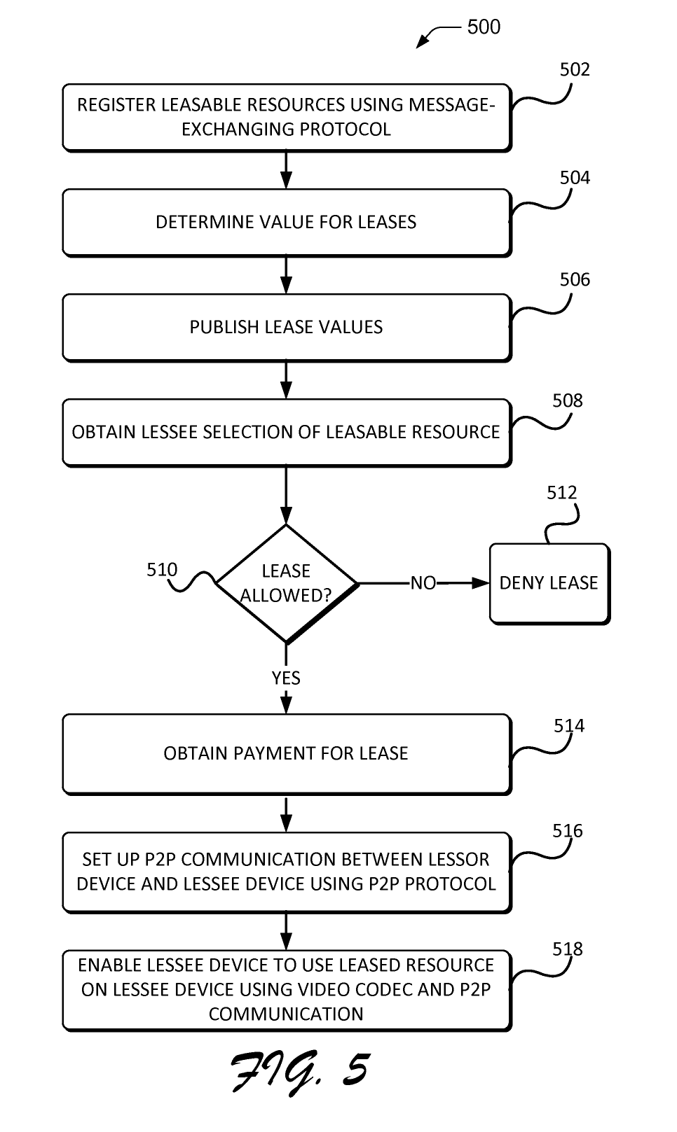

FIG. 5 is a flowchart of a method 500 for leasing computing resources according to one or more implementations described herein.

In a block 502, the resource-leasing tool 300 registers leasable resources using a message-exchanging protocol. In one or more implementations, the directory service 102 registers the resources that are installed on the desktops 104, 106, and 108, as well as the laptop 110. The directory service 102 uses the message-exchanging protocol XMPP to register resources that are installed on the desktops 104, 106, and 108, and the laptop 110. In one or more implementations, the desktops 104, 106, and 108, and the laptop 110 and their installed applications are registered with the directory service 102 by exchanging messages with the directory service 102. For example, the desktops 104, 106, and 108, the laptop 110, as well as other computing devices in the environment 100 register their processor type and speed, memory type and amount, installed applications, etc., with the directory service 102.

In a block 504, the resource-leasing tool 300 determines values for leases. In one or more implementations, the lease-valuation system 302 determines values for leases based on the time of lease, the duration of the lease, the type of resource, etc.

In a block 506, the resource-leasing tool 300 publishes lease values. In one or more implementations, the directory service 102 publishes lease values to the laptop 110 on the laptop 110's user interface 120.

In a block 508, the resource-leasing tool 300 obtains a lessee selection of a leasable resource. In one or more implementations, the lessee 130 checks the box 210 for the word processing application. The directory service 102 receives an indication that the lessee 130 has selected the word processing application 124 and interprets the selection of the box 210 as a request to lease the word processing application. Alternatively, the lessee 130 checks the box 212 to lease the programming language compiler, the box 214 to lease the web browser, and/or the box 216 to lease the user interface. The directory service 102 interprets the selection of the boxes 210, 212, 214, and/or 216 as a request to lease the selected resources.

In a block 510, the resource-leasing tool 300 determines whether the lease is allowed. In one or more implementation, the lease verifier 304 determines whether the lessee 130 has permission to lease the selected application.

For example, the lease verifier 304 determines whether the lessee 130 has permission to access the word processing application. If the lease verifier 304 determines the lessee 130 does not have permission to access the word processing application, then control of the method 500 passes to a block 512, in which the lessee 130 is denied access to the word processing application.

If the lease verifier 304 determines the lessee 130 has permission to access the word processing application, then control of the method 500 passes to a block 514.

In block 514, the resource-leasing tool 300 obtains payment for the lease. In one or more implementations, the payment system 306 obtains payment from the lessee 130 for the lease of the word processing application.

In a block 516, the resource-leasing tool 300 sets up peer-to-peer communication between the lessor device and the lessee device using a P2P communication protocol. In one or more implementations, the P2P module 308 sets up a peer-to-peer connection between the laptop 110 and the desktop 108 using libjingle, Skype, or other suitable P2P communication protocol.

In a block 518, the resource-leasing tool 300 enables the lessee device to use the leased application on the lessee device using a video codec and P2P communication. In one or more implementations, the resource-leasing tool 300 uses the P2P module 308 to set up and maintain a peer-to-peer session between the desktop 108 and the laptop 110. In one or more implementations, the resource-leasing tool 300 uses the remote access module 310 to transmit and receive data between the desktop 108 and the laptop 110 to enable the lessee 130 to use the word processing application 124 on the laptop 110 while the word processing application 124 is running on the desktop 108.

The method 500 is illustrated as a collection of blocks in a logical flow graph, which represents a sequence of operations that can be implemented in mechanics alone or a combination with hardware, software, and/or firmware. In the context of software/firmware, the blocks represent instructions stored on one or more computer-readable storage media that, when executed by one or more processors, perform the recited operations. Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

### Example Computing Environment

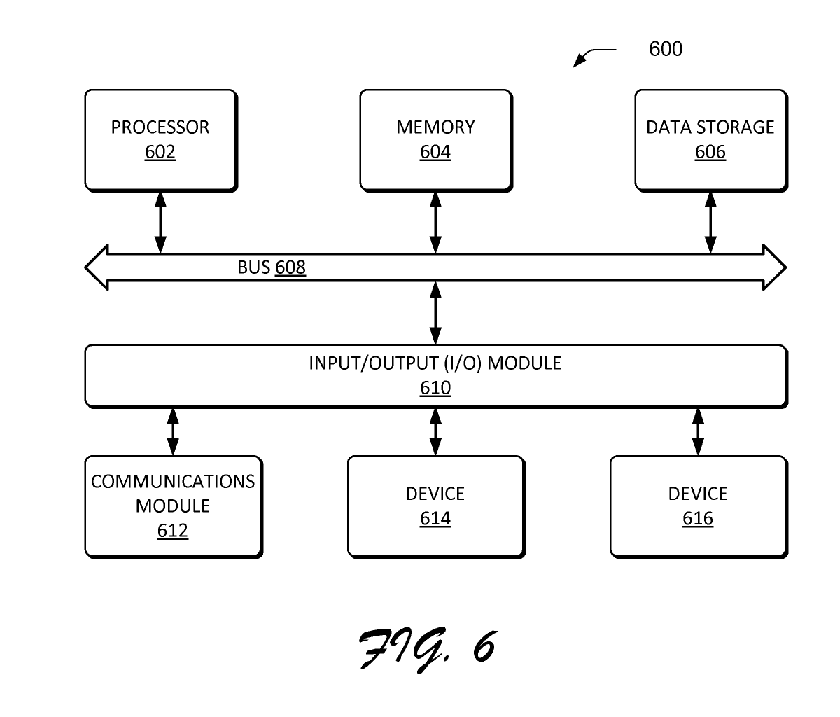

FIG. 6 is a high-level block diagram illustrating an example computer system 600 suitable for implementing the enterprise environment 100 of FIG. 1. In certain aspects, the computer system 600 may be implemented using hardware or a combination of software and hardware.

The illustrated computer system 600 includes a processor 602, a memory 604, and data storage 606 coupled to a bus 608 or other communication mechanism for communicating information. An input/output (I/O) module 610 is also coupled to the bus 608. A communications module 612, a device 614, and a device 616 are coupled to the I/O module 610.

The processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. The processor 602 may be used for processing information. The processor 602 can be supplemented by, or incorporated in, special purpose logic circuitry.

The memory 604 may be Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device used for storing information, a computer program, and/or instructions to be executed by the processor 602. They memory 604 may store code that creates an execution environment for one or more computer programs used to implement technology described herein.

A computer program as discussed herein does not necessarily correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Unless indicated otherwise by the context, a module refers to a component that is hardware, firmware, and/or a combination thereof with software (e.g., a computer program.) A computer program as discussed herein does not necessarily correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The instructions may be implemented in one or more computer program products, i.e., one or more modules of computer program instructions encoded on one or more computer readable media for execution by, or to control the operation of, the computer system 600, and according to any method well known to those of skill in the art. The term “computer-readable media” includes computer-storage media. For example, computer-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM))

The data storage 606 may be a magnetic disk or optical disk, for example. The data storage 606 may function to store information and instructions to be used by the processor 602 and other components in the computer system 600.

The bus 608 may be any suitable mechanism that allows information to be exchanged between components coupled to the bus 608. For example, the bus 608 may be transmission media such as coaxial cables, copper wire, and fiber optics, optical signals, and the like.

The I/O module 610 can be any input/output module. Example input/output modules 610 include data ports such as Universal Serial Bus (USB) ports.

The communications module 612 may include networking interface cards, such as Ethernet cards and modems.

The device 614 may be an input device. Example devices 614 include a keyboard, a pointing device, a mouse, or a trackball, by which a user can provide input to the computer system 600.

The device 616 may be an output device. Example devices 616 include displays such as cathode ray tubes (CRT) or liquid crystal display (LCD) monitors that display information, such as web pages, for example, to the user.

One or more implementations are described herein with reference to illustrations for particular applications. It should be understood that the implementations are not intended to be limiting. Those skilled in the art with access to the teachings provided herein will recognize additional modifications, applications, and implementations within the scope thereof and additional fields in which the technology would be of significant utility. In the above description of example implementations, for purposes of explanation, specific numbers, materials, configurations, and other details are set forth in order to better explain implementations as claimed. However, it will be apparent to one skilled in the art that the claims may be practiced using details different than the examples described herein. In other instances, well-known features are omitted or simplified to clarify the description of the example implementations.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

In the claims appended herein, the inventor invokes 35 U.S.C. §112, paragraph 6 only when the words “means for” or “steps for” are used in the claim. If such words are not used in a claim, then the inventor does not intend for the claim to be construed to cover the corresponding structure, material, or acts described herein (and equivalents thereof) in accordance with 35 U.S.C. §112, paragraph 6.

1. A system for resource-leasing, the system comprising:
one or more processors; and
a machine-readable medium comprising instructions stored therein, which when executed by the processors, cause the processors to perform operations comprising:
registering, via a message-exchanging communication protocol, a resource on a lessor computing device that is available for lease;
obtaining an indication that a lessee wants to lease the resource for use on a lessee computing device;
determining whether the lessee has permission to lease the resource;
determining, in response to a determination that the lessee has permission to lease the resource, a value for a lease by the lessee of the resource based upon one or more of a start time for the lease, a duration of the lease, or the resource being leased, wherein determining the value for the lease comprises obtaining bids by one or more potential lessees for the lease of the resource;
facilitating a peer-to-peer connection between the lessor computing device and a lessee computing device using a peer-to-peer communication protocol in response to the determination that the lessee has permission to lease the resource; and
enabling, using the peer-to-peer connection, the lessee to use the resource on the lessee computing device while the resource is running on the lessor computing device.

2. The system according to claim 1 wherein the resource includes a web browser.

3. The system according to claim 1 wherein the resource includes a programming language compiler.

4. The system according to claim 1 wherein the resource includes an application.

5. The system according to claim 1 wherein determining the value for the lease is based on an auction system.

6. The system according to claim 1 wherein determining the value for the lease is based on a fixed-value valuation system.

7. The system according to claim 1 wherein determining the value for the lease is based on an advertisement-selection system.

8. The system according to claim 1, the operations further comprising obtaining payment for the lease from the lessee in response to the determination that the lessee has permission to lease the resource.

9. The system according to claim 1 wherein the value for the lease of the resource includes an advertisement viewing.

10. The system according to claim 1 wherein the value for the lease of the resource includes one or more of a discount or a coupon.

11. The system according to claim 1 the operations further comprising obtaining payment for the lease from the lessee in response to the determination that the lessee has permission to lease the resource, based on an escrow system.

12. The system according to claim 1 wherein the facilitating is based on libjingle.

13. The system according to claim 1 wherein the enabling is based on a video codec.

14. The system according to claim 1 wherein the message-exchanging communication protocol includes Extensible Messaging and Presence Protocol (XMPP).

15. The system according to claim 1 wherein determining whether the lessee has permission to lease the resource comprises querying whether the lessee has permission to lease the resource.

16. A method comprising:
registering, via a message-exchanging protocol, a resource on a lessor computing device that is available for lease, wherein the resource directory device;
obtaining an indication that a lessee wants to lease the resource on a lessee computing device;
in response to obtaining an indication that a lessee wants to lease the resource, determining whether the lessee has permission to use the resource;
in response to a determination that the lessee has permission to use the resource, determining a value for a lease by the lessee of the resource based on one or more of a start time for the lease, a duration of the lease, or the resource being leased, wherein determining the value for the lease comprises obtaining bids by one or more potential lessees for the lease of the resource;
in response to the determination that the lessee has permission to use the resource, facilitating a peer-to-peer connection between the lessor computing device and a lessee computing device using a peer-to-peer communication protocol; and
enabling, using the peer-to-peer connection and a remote access module, the lessee to use the resource on the lessee computing device while the resource is running on the lessor computing device.

17. (canceled)

18. A method according to claim 16 wherein determining a value for the lease of the resource includes determining an advertisement that is to be viewed for the lease of the resource.

19. A method according to claim 16 wherein the resource includes a web browser.

20. A method according to claim 16 wherein the resource includes a user interface.

21. A method according to claim 16 further comprising establishing the peer-to-peer connection between the lessor's client computing device and the lessee's client computing device using libjingle.

22. A method according to claim 16 wherein the message-exchanging protocol includes an Extensible Messaging and Presence Protocol (XMPP).

23. A method according to claim 16 wherein the resource on the lessor's client computing device includes a programming language compiler.

24. A method according to claim 16 further comprising obtaining payment from the lessee for the lease in response to determining that the lessee has permission to use the resource.

25. One or more non-transitory computer-readable media storing processor-executable instructions that when executed cause one or more processors to perform a method comprising:
registering, via a message-exchanging protocol, a resource on a lessor computing device that is available for lease, wherein the resource directory device;
obtaining an indication that a lessee wants to lease the resource on a lessee computing device;
in response to obtaining an indication that a lessee wants to lease the resource, determining whether the lessee has permission to use the resource;
in response to a determination that the lessee has permission to use the resource, determining a value for a lease by the lessee of the resource based on one or more of a start time for the lease, a duration of the lease, or the resource being leased, wherein determining the value for the lease comprises obtaining bids by one or more potential lessees for the lease of the resource;
in response to the determination that the lessee has permission to use the resource, facilitating a peer-to-peer connection between the lessor computing device and a lessee computing device using a peer-to-peer communication protocol; and
enabling, using the peer-to-peer connection and a remote access module, the lessee to use the resource on the lessee computing device while the resource is running on the lessor computing device.

26. (canceled)

27. One or more non-transitory computer-readable media according to claim 25 wherein determining a value for the lease of the resource includes determining an advertisement that is to be viewed for the lease of the resource.

28. One or more non-transitory computer-readable media according to claim 25 wherein the resource includes a web browser.

29. One or more non-transitory computer-readable media according to claim 25 wherein the resource includes a user interface.

30. One or more non-transitory computer-readable media according to claim 25 wherein the resource includes a programming language compiler.

31. (canceled)

32. One or more non-transitory computer-readable media according to claim 25 wherein determining the value for the lease of the resource includes determining a fixed-value for the lease of the resource.

33. One or more non-transitory computer-readable media according to claim 25 wherein determining the value for the lease of the resource includes selecting an advertisement for the lessee to view for the lease of the resource.
